(19) United States
(12) Patent Application Publication
(10) Pub. No.: US 2013/0161449 A1
(43) Pub. Date: Jun. 27, 2013

(54) LATCHING DETECTION AND INDICATION SYSTEM FOR AERIAL REFUELING COUPLINGS

(71) Applicants: José Luis Marcos Montes, Madrid (ES); Martin Espinosa Sánchez, Madrid (ES); Jorge Terrón Blanco, Madrid (ES); Samuel de la Fuente López, Madrid (ES)

(72) Inventors: José Luis Marcos Montes, Madrid (ES); Martin Espinosa Sánchez, Madrid (ES); Jorge Terrón Blanco, Madrid (ES); Samuel de la Fuente López, Madrid (ES)

(73) Assignee: EADS Construcciones Aeronauticas, S.A., Madrid (ES)

(21) Appl. No.: 13/455,562

(22) Filed: Apr. 25, 2012

(30) Foreign Application Priority Data
Dec. 23, 2011 (EP) 11382398.3

(51) Int. Cl. B64D 39/06

(52) U.S. Cl. 244/135 A

(57) ABSTRACT

Reception coupling unit of a hose and drogue device of a tanker aircraft with the probe of a receiver aircraft for in-flight refueling, including, respectively, first and second cooperating latching devices that can be positioned in one or more latching states in a refueling operation, in which the reception coupling unit includes at least a detector of the latching states and at least a first indication device and/or a second indication device for providing, respectively, to the pilot of the receiver aircraft and/or to the crew of the tanker aircraft indications that the cooperating latching devices are positioned in one or more of the latching states, the detector being operatively connected, respectively, to a first indication device and/or to a second indication device.

### CROSS-REFERENCE TO RELATED APPLICATION

This application claims the benefit of European Patent Application 11382398.3, filed on Dec. 23, 2011, the entire contents of which is incorporated by reference.

### BACKGROUND OF THE INVENTION

1. Field of the Invention

The present invention relates generally to aircraft refueling hoses and more specifically to the latching system that ensures the connection to the probe to the reception coupling unit of the hose.

2. Background

One method for in-flight refueling operations is based on the use of a hose and drogue device that makes contact with a probe of the receiver aircraft allowing fuel to pass from the tanker aircraft to the receiver aircraft.

The drogue is used to stabilize the hose trailing from a fuel tanker aircraft. It also provides the drag to maintain the hose catenary and the mating force with a probe from a receiver aircraft to be refueled. The drogue is attached to a reception coupling unit at the end of the hose, which has a passage for receiving the probe nozzle, and supports a canopy or parachute surrounding the passage opening and providing drag for the coupling unit.

The hose and drogue device may have illumination means as those disclosed in US 2009/0302161 to assist the receiver pilot to align the probe with the drogue and reception coupling passage in low light or darkness.

The connection between the probe and the reception coupling unit of the hose shall be ensured by a latching system.

U.S. Pat. No. 2,692,102 and U.S. Pat. No. 3,059,895 disclose a latching system based on some rollers which run on the receiver probe and which are allocated on a circumferential groove of the receiver probe when the full contact is performed. Those rollers are kept pressed against the receiver probe by spring-plunger assemblies.

This latching system has the disadvantage that the connection between the probe and the hose reception coupling unit can be kept in an intermediate latching state, where the latching system is not in its locking position. At those conditions, the refueling operation can be performed with relative movements between the hose reception coupling unit and the receiver probe.

The present invention is focused to the solution of this problem.

### SUMMARY OF THE INVENTION

It is an object of the present invention to provide a latching system for in-flight refueling operations between a tanker aircraft and a receiver aircraft using a hose and drogue device that assures that the refueling operation is performed without relative movements between the tanker reception coupling unit and the receiver probe.

In one aspect, this and other objects are met by a reception coupling unit of a hose and drogue device of a tanker aircraft with the probe of a receiver aircraft for in-flight refueling, the reception coupling unit and the probe comprising, respectively, first and second cooperating latching means that can be positioned in a non-latched state, in an intermediate latching state and in a latched state during a refueling operation, the reception coupling unit comprising at least a detector of said latching states and at least a first indication means and/or a second indication means for providing, respectively, to the pilot of the receiver aircraft and/or to the crew of the tanker aircraft indications that said cooperating latching means are positioned in one or more of said latching states, said detector being operatively connected, respectively, to a first indication means and/or to a second indication means.

In one embodiment, said second cooperating means is a circumferential groove in the probe and said first cooperating means comprises at least a roller arranged in the reception coupling unit for running over the incoming probe, then being said latching means in an intermediate latching state, until the roller is allocated on said circumferential groove, then being said latching means in a latched state. Therefore latching detection means operatively connected to the indication means for the pilot of the receiver aircraft and/or to the crew of the tanker aircraft are incorporated to known latching systems allowing the pilot of the receiver aircraft and/or the crew of the tanker aircraft to take the required corrective actions that lead to a proper connection.

In one embodiment, the reception coupling unit comprises a detector for said roller which is operatively connected to a first indication means and/or to a second indication means for activating said indication means when the roller is positioned in said intermediate latching state. Where the detector may be a position detector, such as an optical sensing element or a mechanical sensing element capable of detecting the position of the roller in the intermediate latching state.

In one embodiment, said first indication means is a light source, preferably a Light Emitting Diode (LED) device, arranged in the external surface of the reception coupling unit connected to an electric circuit having a switch for turning ON/OFF said light source which is controlled by said detector which closes the circuit when the roller is in an intermediate latching state and opens the circuit otherwise. Therefore, a visual indication means of the intermediate latching state for the pilot of the receiver aircraft is provided.

In one embodiment, said electric circuit comprises a flasher component so that said light source will emit a flashing light when the electric circuit is closed.

In one embodiment, said second indication means is a signal emitter, it maybe be a radio emitter or a micro-wave radio emitter, connected to an electric circuit having a switch for turning ON/OFF said signal emitter which is controlled by said detector. An indication means, which may be an acoustic indication means, of the intermediate latching state for the crew of the tanker aircraft is provided.

In one embodiment, said electric circuit comprises an air-driven generator and a backup battery as electrical energy sources.

In one embodiment said first indication means is a sliding pin between recessed and protruding positions with respect to the external surface of the reception coupling unit connected to a mechanical detector arranged to move the sliding pin to the protruding position when said roller is in an intermediate latching state and to the recessed position otherwise. A visual indication means of the intermediate latching state for the pilot of the receiver aircraft is provided.

In one embodiment said mechanical detector is an assembly of a cam and a lever arranged for interacting with said roller to move the sliding pin to the protruding position in an intermediate latching state, so that it can be seen by the receptor pilot, and to the recessed position otherwise.

Other characteristics and advantages of the present invention will be clear from the following detailed description of embodiments illustrative of its object in relation to the attached figures.

### BRIEF DESCRIPTION OF THE DRAWINGS

FIG. 1 is a schematic view of a refueling operation between a tanker aircraft and a receiver aircraft using a hose and drogue device.

FIG. 2 is a cross section view of the reception coupling unit of a hose and drogue device.

FIGS. 3a, 3b and 3c are schematic cross sectional views of one embodiment of the latching detection and indication means according to the present invention in three different latching states.

FIG. 4 is a schematic view of the electric circuit as depicted in FIGS. 3a-3c.

FIG. 5 is a schematic cross sectional view of one embodiment of the latching detection and indication means of the intermediate latching state according to the present invention.

FIG. 6 is a schematic view of the electric circuit as depicted in FIG. 5.

FIG. 7 is a schematic view of the electric circuit used in one embodiment of the latching detection and indication means according to the present invention.

FIGS. 8a, 8b and 8c are schematic cross sectional views of one embodiment of the latching detection and indication means according to the present invention in three different latching states.

### DETAILED DESCRIPTION OF THE PREFERRED EMBODIMENTS

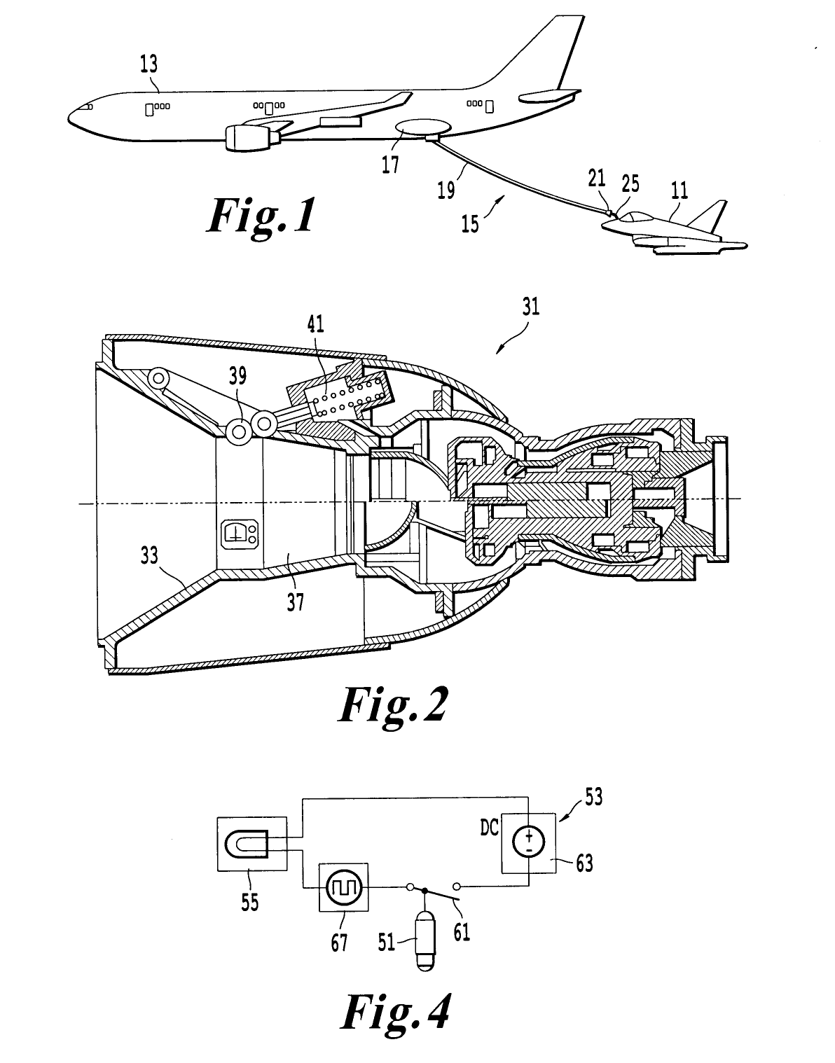

A usual method for in-flight refueling operations is illustrated in FIG. 1 and is based on the use of a hose and drogue device 15. This refueling method employs a flexible hose 19 that trails from a refueling unit 17 (pod or FRU) located in the tanker aircraft 13 with a drogue 21 (a fitting resembling a windsock or shuttlecock) attached at its narrow end. The receiver 11 has a probe 25, which is a rigid arm placed on the aircraft's nose or fuselage with a valve that is closed until it mates with the end of the hose after which it opens and allows fuel to pass from the tanker aircraft 13 to the receiver aircraft 11.

FIG. 2 shows the reception coupling unit 31 at the end of the hose 19 with an external surface 33 and an internal passage 37 for receiving the probe 25.

The reception coupling unit 31 and the probe 25 shall have cooperating latching means for assuring that the probe 25 is properly connected to the hose 19 to proceed with the refueling operation.

According to this invention, the reception coupling unit 31 is also provided with detection and indication means of the latching state of said cooperating latching means so that the pilot of the receiver aircraft 11 and/or the crew of the tanker aircraft 13 can receive indications concerning said latching state.

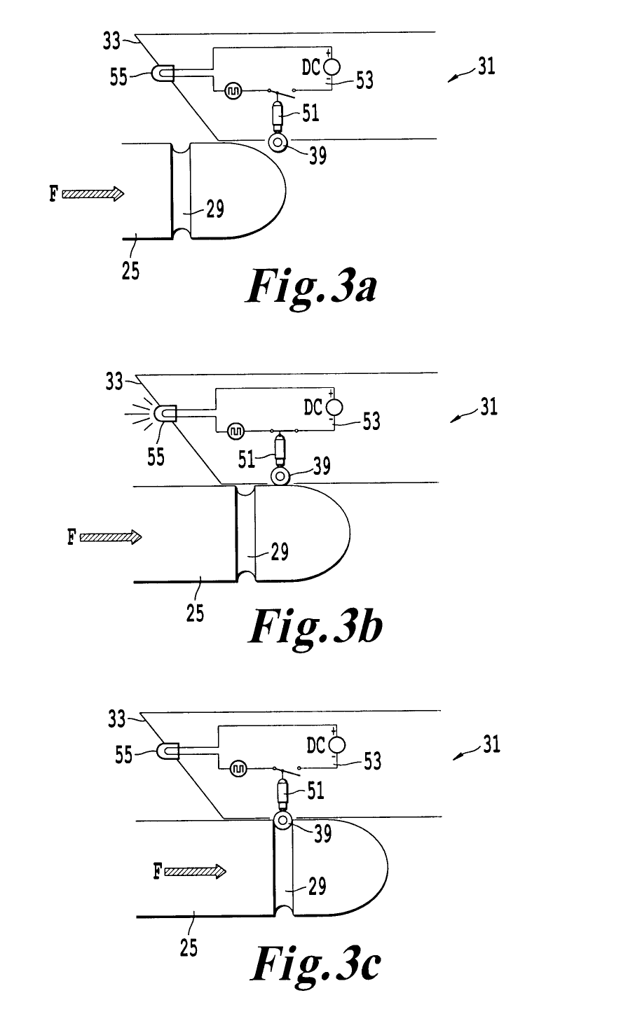

Some embodiments of the invention will now be described. They may refer to a known latching system which is based on at least one roller 39 located in the internal passage 37 of the reception coupling unit 31, that is pressed by the probe 25 by a spring-plunger assembly 41 (see FIG. 2), as the cooperating means in the reception coupling unit 31, and on a circumferential groove 29 as the cooperating means in the probe 25 (see FIGS. 3a, 3b, 3c).

In FIG. 3a, the roller 39 is at a fully extended position because it has not yet entered into contact with the probe 25. Arrow F indicates the direction of the displacement of the incoming probe 25 with respect to the reception coupling unit 31.

In FIG. 3b, the roller 39 is not at a fully extended position because it is pressed by the probe 25.

In FIG. 3c, the roller 39 is at a fully extended position because it is inserted into the circumferential groove 29 of the probe 25.

When the roller 39 is at the fully extended position, two possible latching states can take place: the probe 25 may be fully disconnected (FIG. 3a), i.e. a non-latching state, or it may be properly connected (FIG. 3c), i.e. a latching state.

When the roller 39 is pressed by the probe 25 (FIG. 3b), an intermediate latching state takes place which means that the latching system is not locked.

In one embodiment of the invention, illustrated in FIGS. 3a, 3b, 3c, the reception coupling unit 31 is provided with detection and indication means of the intermediate latching state of said cooperating latching means so that the pilot of the receiver aircraft 11 can receive indications concerning said latching state.

The reception coupling unit 31 comprises position detectors 51, as detection means of the latching state of the roller 39, coupled to a switch 61 of an electric circuit 53.

The electric circuit 53 (see FIG. 4) comprises an air-driven electric generator 63 and a backup battery (not shown) as electrical energy sources, a flasher component 67 and a source of light 55 placed in the external surface 33 of the reception coupling unit 31 as a first indication means of the intermediate latching state for the pilot of the receiver aircraft 11.

When the roller 39 is pressed by the probe 25 (FIG. 3b), the position detector 51 closes the electric circuit 53 and the source of light 55 emits a flashing light advising the pilot of the receptor aircraft 11 of this circumstance so that he can take the required corrective actions that can lead to a proper connection.

When the roller 39 is at the fully extended position (FIGS. 3a and 3c) the electric circuit 53 remains open so that the source of light 55 is turned OFF.

If the latching system has three rollers 39 spaced around the internal passage 37 of the reception coupling unit 21, which may occur in the above-mentioned latching systems, this embodiment may comprise individual detection and indication means for each roller 39 and therefore the reception coupling unit 31 will be provided with three sources of light 55 as indication means for the pilot of the receptor aircraft 11 which will be spaced around the external surface 33 of the reception coupling unit 31 facilitating therefore that the pilot of the receptor aircraft 11 can be informed that the probe 25 is in an intermediate latching state in any position of the reception coupling unit 31.

Preferably the source of light 55 is a Light Emitting Diode (LED) device.

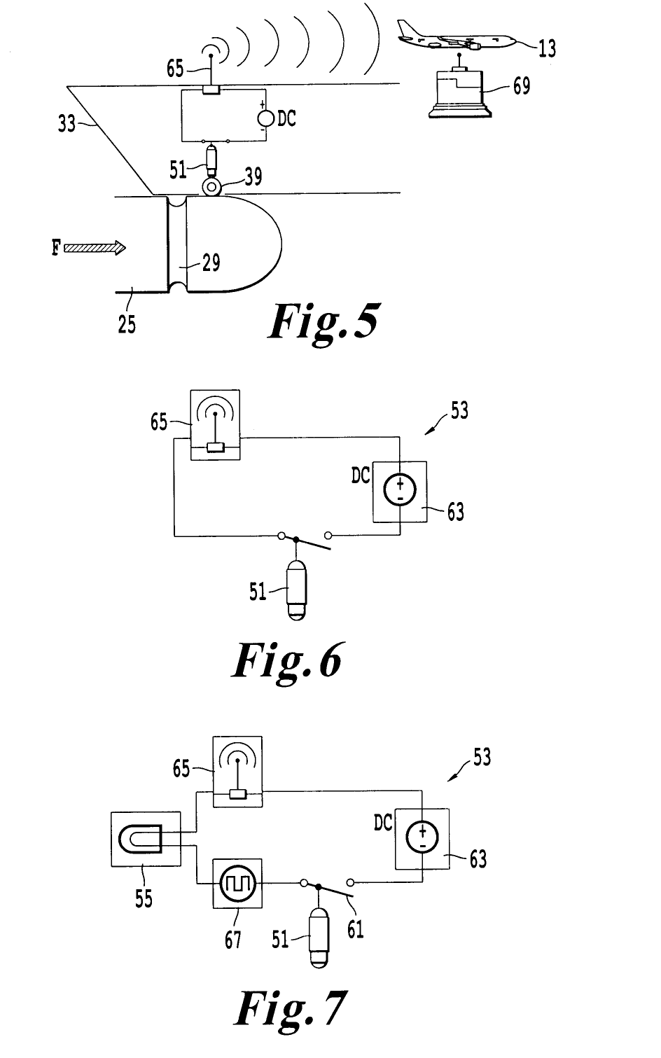

In another embodiment of the invention, illustrated in FIGS. 5 and 6, the reception coupling unit 31 is provided with detection and indication means of the intermediate latching state of said cooperating latching means so that the crew of the tanker aircraft 13 can receive indications concerning said intermediate latching state.

The reception coupling unit 31 comprises a position detector 51, as detection means of the latching state of the roller 39, coupled to a switch 61 of an electric circuit 53.

The electric circuit 53 (see FIG. 6) comprises an air-driven electric generator 63 and a backup battery (not shown) as electrical energy sources, and a signal emitter 65 as a second indication means of the intermediate latching state for the crew of the tanker aircraft 13.

When the roller 39 is pressed by the probe 25 (see FIG. 5), the position detector 51 closes the electric circuit 53 and the signal emitter 65 emits signals advising the crew of the tanker aircraft 13 of this circumstance so that they can take the required corrective actions that can lead to a proper connection. The tanker aircraft 13 is provided with a suitable receptor device 69 of said signals.

Preferably the signal emitter 65 is a radio emitter, particularly a micro-wave radio emitter.

If the latching system has three rollers 39 spaced around the internal passage 37 of the reception coupling unit 21, which may occur in the above-mentioned latching systems, this embodiment can comprise individual detection and indication means for each roller 39 and therefore the reception coupling unit 31 will be provided with three radio emitters as indication means for the crew of the tanker aircraft 13, or individual detection means for each roller 39 associated to a single indication means for the three rollers 39.

In another embodiment, the reception coupling unit 31 is provided with detection and indication means of the intermediate latching state of said cooperating latching means so that the pilot of the receiver aircraft 11 and the crew of the tanker aircraft 13 can receive indications concerning said latching state.

As in the above-mentioned embodiments, the reception coupling unit 31 comprises a position detector 51, as detection means of the latching state of the roller 39, coupled to a switch 61 of an electric circuit 53.

The electric circuit 53 (see FIG. 7) comprises an air-driven electric generator 63 and a backup battery as electrical energy sources, a flasher component 67, a source of light 55 placed in the external surface 33 of the reception coupling unit 31 as a first indication means of the intermediate latching state for the pilot of the receiver aircraft 11 and a signal emitter 65 as a second indication means of the intermediate latching state for the crew of the tanker aircraft.

When the position detector 51 closes the electric circuit 53, the source of light 55 emits flashing lights and the signal emitter 65 emits signals advising, respectively, the pilot of the receptor aircraft 11 and the crew of the tanker aircraft 13 that the latching system is in an intermediate latching state so that they can take the required corrective actions that can lead to a proper connection.

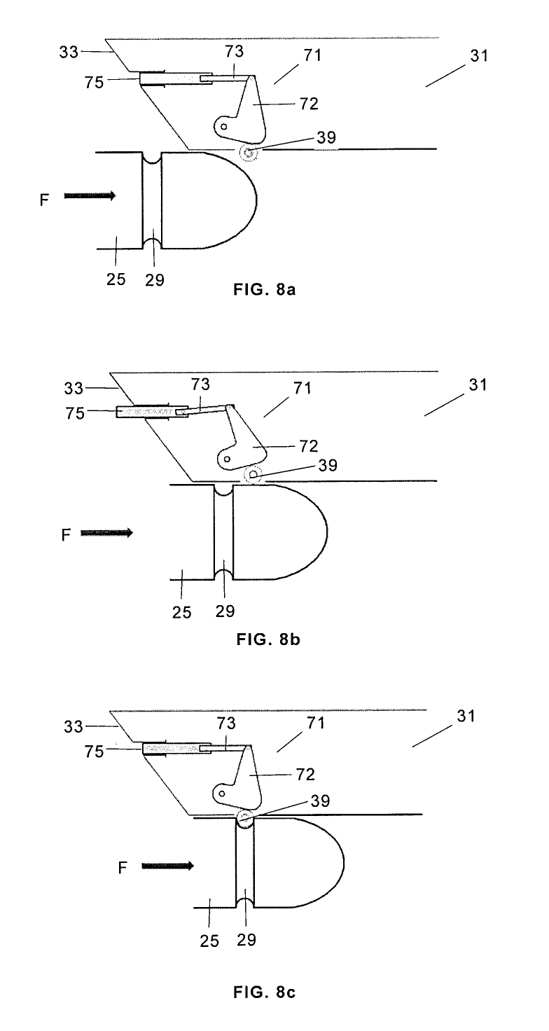

In another embodiment of the invention illustrated in FIGS. 8a, 8b, 8c, the detector 71 of the latching state of the roller 39 is an assembly of a cam 72 and a lever 73. The lever 73 is arranged to move a pin 75, which is the first indication means for the pilot of the receiver aircraft 11, between a recessed and a protruding position with respect to the external surface 33 of the reception coupling unit 31.

When the roller 39 is pressed by the probe 25 (FIG. 8b), the assembly of the cam 71 and the lever 73 moves the pin 75 to a protruding position making it therefore visible for the pilot of the receptor aircraft 11 so that he can take the required corrective actions that can lead to a proper connection.

When the roller 39 is at the fully extended position (FIGS. 8a and 8c) the pin 75 remains in a recessed position.

The pin 75 may be understood as a body suitable to be seen by the pilot of the receiver aircraft 11 on the external surface 33 of the reception coupling unit 31 in a refueling operation.

This embodiment is advisable for coupling units 31 already provided with illumination means so that they can be fully operative at night or during poor weather conditions.

1. A reception coupling unit of a hose and drogue device of a tanker aircraft with a probe of a receiver aircraft for in-flight refueling, the reception coupling unit and the probe comprising, respectively, first and second cooperating latching means that can be positioned in a non-latched state, in an intermediate latching state and in a latched state during a refueling operation, wherein the reception coupling unit comprises at least a detector of said latching states and at least a first indication means and/or a second indication means for providing, respectively, to a pilot of the receiver aircraft and/or to a crew of the tanker aircraft indications that said cooperating latching means are positioned in one or more of said latching states, said detector being operatively connected, respectively, to a first indication means and/or to a second indication means.

2. A reception coupling unit according to claim 1, wherein said second cooperating latching means is a circumferential groove in the probe and said first cooperating means comprises at least one roller arranged in the reception coupling unit for running over the incoming probe, then being said latching means in an intermediate latching state, until the roller is allocated on said circumferential groove, then being said latching means in a latched state.

3. A reception coupling unit according to claim 2, wherein the detector for said roller is operatively connected to the first indication means and/or to the second indication means for activating said indication means when said roller is positioned in said intermediate latching state.

4. A reception coupling unit according to claim 3, wherein:
said detector is a position detector arranged for closing a switch in an electric circuit provided with an electrical energy source when said roller is in the intermediate latching state and for opening said switch otherwise;
said first indication means is a light source arranged in an external surface of said reception coupling unit and connected to said electric circuit; and
said second indication means is a signal emitter connected to said electric circuit.

5. A reception coupling unit according to claim 4, wherein said electric circuit comprises an air-driven generator and a backup battery, as electrical energy sources.

6. A reception coupling unit according to claim 4, wherein said electric circuit further comprises a flasher component so that said light source will emit a flashing light when the electric circuit is closed.

7. A reception coupling unit according to claim 6, wherein said light source is a LED device.

8. A reception coupling unit according to claim 4, wherein said signal emitter is a radio emitter.

9. A reception coupling unit according to claim 8, wherein said radio emitter is a micro-wave radio emitter.

10. A reception coupling unit according to claim 4, wherein said signal emitter is arranged as a single emitter when the reception coupling comprises more than one roller.

11. A reception coupling unit according to claim 2, wherein the detector for said roller is operatively connected to the first indication means for activating said first indication means when said roller is positioned in said intermediate latching state.

12. A reception coupling unit according to claim 11, wherein:
the first indication means is a sliding pin between a recessed and a protruding position with respect to an external surface of the reception coupling unit;
said detector is a mechanical detector arranged to move the sliding pin to the protruding position when said roller is in the intermediate latching state and to the recessed position otherwise.

13. A reception coupling unit according to claim 12, wherein said detector is an assembly of a cam and a lever arranged for interacting with said roller so that the lever, which is coupled to said sliding pin, moves the sliding pin to the protruding position when said roller is in the intermediate latching state and to the recessed position otherwise.

14. A tanker aircraft comprising a hose and drogue device according to claim 1.

15. A tanker aircraft according to claim 14, comprising a receptor device of the indications transmitted by said second indication means.
